(19) United States
(12) Patent Application Publication
(10) Pub. No.: US 2007/0121535 A1
(43) Pub. Date: May 31, 2007

(54) Dynamic transmit power for non-canonical transmission formats

(76) Inventors: Wanshi Chen, San Diego, CA (US); Mahesh A. Makhijani, San Diego, CA (US)

Correspondence Address: COATS & BENNETT, PLLC, 1400 Crescent Green, Suite 300, Cary, NC, 27518, US

(21) Appl. No.: 11/239,853

(22) Filed: Sep. 30, 2005

(51) Int. Cl. H04B 7/185; H04Q 7/00

(52) U.S. Cl. 370/317; 370/332

(57) ABSTRACT

Data packets on forward link packet data channels are typically transmitted at the full available power of the base station. When a non-canonical transmission format associated with a received DRC index is selected for encoding the packet data, the data may be transmitted with less that full available power, achieving the target FER due to shorter packets, and reducing system interference. The transmit power may be selected as a function of the required FER, payload size (associated physical layer format) and packet format (single- or multiple-user packet). The transmit power may also be based on the selected TF, the QoS needs of the packet data, or current system load information.

### BACKGROUND

The present invention relates generally to the field of wireless communication networks and in particular to a system and method of dynamically altering transmit power for non-canonical transmission formats.

The 3rd Generation (3G) wireless communication networks provide mobile users wireless access to packet data networks, such as the Internet. Many applications and services, once available only to users at fixed terminals, are now being made available via wireless communication networks to mobile users. Real-time streaming video and music, on-line interactive gaming, text messaging, email, web browsing and Voice over IP (VoIP), are just a few examples of data services now being provided via wireless networks to mobile users.

The demand for such wireless data services has led to the development of high speed packet data channels to provide the high data rates that such services require. High speed packet data channels are employed on the forward link in Access Networks (AN) such as cdma2000 (both 1xEV-DO and 1x-EV-DV) and High Speed Downlink Packet Data Access (HSPDA) systems. The high speed packet data channel is a shared channel. Packet data signals from a Base Station (BS) to the Access Terminals (AT) (also known as mobile stations or mobile terminals) are time-multiplexed into “slots” and are transmitted at full power.

The slot times and data rates allocated for transmissions to the ATs depend on the channel conditions seen by each AT. The ATs measure the signal quality on the forward link and send channel quality information on the reverse link overhead channels to the BS. The channel quality information may comprise either a channel quality indicator (CQI) in 1xEV-DV and HSPDA, or a data rate indication in 1xEV-DO.

In particular, in 1xEV-DO Rev. A, each AT reports a Data Rate Control (DRC) Index. As indicated in FIG. 1, fifteen DRC indices are defined, each associated with a specific data rate. Additionally, one or more Transmission Formats (TF) are associated with each DRC index. A TF comprises Payload Size (in bits), the Nominal Transmit Duration (in slots), and the Preamble length (in chips). For each DRC index, the TF specifying the largest packet size (the bold-faced TF as depicted in FIG. 1) is the canonical, or default, TF. However, for DRC indices 0x0-0x9 and 0xb, the BS may select any of the associated TFs for encoding the data packets for transmission to one or more ATs (in Rev. A, packets may be single-user or multi-user). The packet data is encoded according to the selected TF, and in prior art systems is transmitted at the full residual power available at the BS.

If the canonical TF for a received DRC index is selected, a target Frame Error Rate (FER), such as 1%, can be achieved with the nominal transmit duration. If the selected TF is a non-canonical TF for the DRC index, due to a shorter packet size as compared with the canonical TF, the actual FER can be expected to be lower than the target FER for the canonical TF. As a result, the packet is more likely to be early terminated and hence the AN experiences a higher effective transmission rate (or equivalently, lower latency). However, in an interference-limited system such as CDMA, exceeding a quality requirement, such as target FER, is undesirable if the improved performance generates interference (or if reducing performance to the quality requirement reduces interference).

### SUMMARY

According to one or more embodiments of the present invention, when a Base Station (BS) within an Access Network (AN) selects a non-canonical Transmission Format (TF) for a received DRC index, the packet data is transmitted to the Access Terminal (AT) at less than the full available transmit power. The transmit power selected may be configured as a function of the required FER, payload size (associated physical layer format) and packet format (single- or multiple-user packet). The transmit power may also be based on the selected TF, the QoS needs of the packet data, or current system load information.

In one embodiment, the present invention relates to a method of transmitting packet data from a AN to one or more ATs in a wireless communication system. A DRC index is received at the AN from a AT. One of a plurality of TFs associated with the DRC index is selected. If the selected TF is a non-canonical TF for the DRC index, packet data is transmitted to the AT at less than full available power.

In another embodiment, the present invention relates to a method of reducing interference in a CDMA wireless AN. A DRC index is received at the AN from a AT. One of a plurality of TFs associated with the DRC index is selected. If the selected TF is a non-canonical TF for the DRC index, one or more data packets is transmitted to the AT at less than full available power, thereby reducing the interference presented to other ATs as compared to a full power transmission of the data packets.

In yet another embodiment, the present invention relates to a BS in a AN operative to transmit packet data to a AT. The base station includes an air interface transceiver having a variable power amplifier. The BS also includes a processor controlling the variable power amplifier. The processor is also operative to select one of a plurality of TFs associated with a DRC index received from the AT. The BS additionally includes a transmit power control function operative to transmit packet data to the AT at less than full available power if the selected TF is a non-canonical TF for the DRC index.

In still another embodiment, the present invention relates to a method of transmitting packet data from an AN to one or more ATs via a BS in a wireless communication system. An indication of channel quality is received at the BS from a AT. A maximum channel-supported data rate is calculated from the channel quality indication. A required data rate is calculated at the BS. The maximum channel-supported data rate is compared to the required data rate, and if the required data rate is less than the maximum channel-supported data rate, packet data is transmitted to the AT at less than full available power.

### BRIEF DESCRIPTION OF DRAWINGS

FIG. 1 is a table of Preamble Lengths and Transmission Formats for DCR indices.

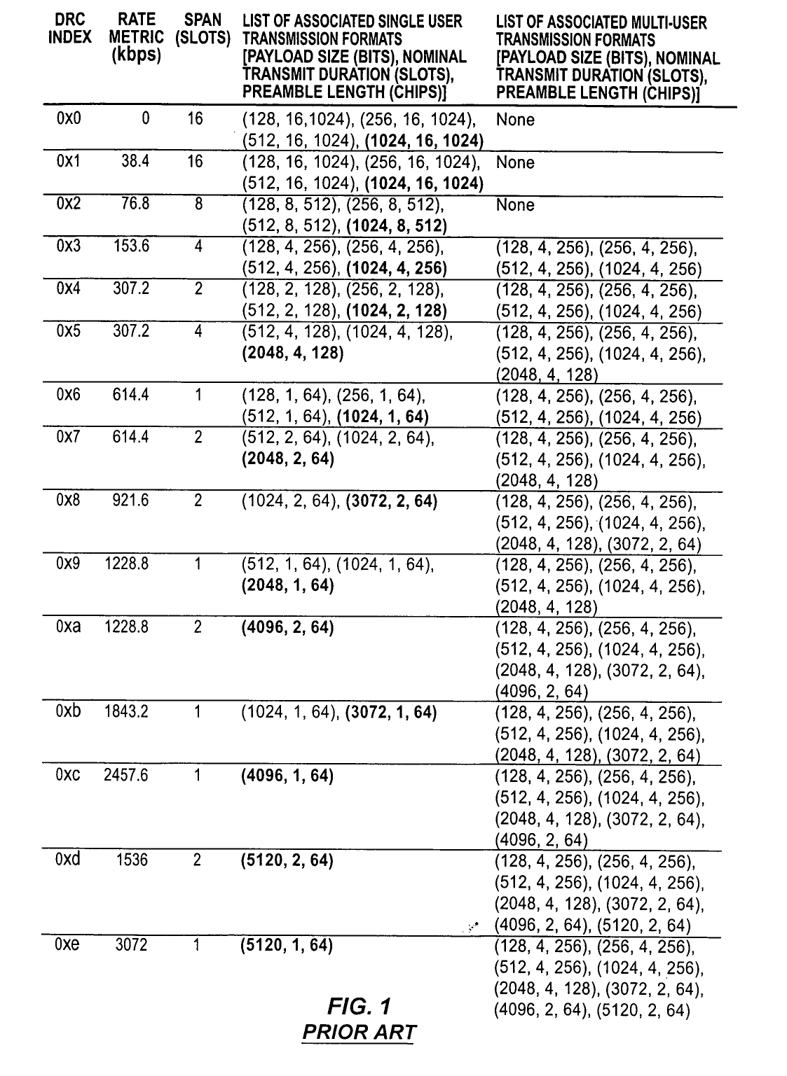

FIG. 2 is a functional block diagram of the packet data side of a wireless communication network.

FIG. 3 is a functional block diagram of a base station.

FIG. 4 is a flow diagram of a method of transmitting packet data.

### DETAILED DESCRIPTION

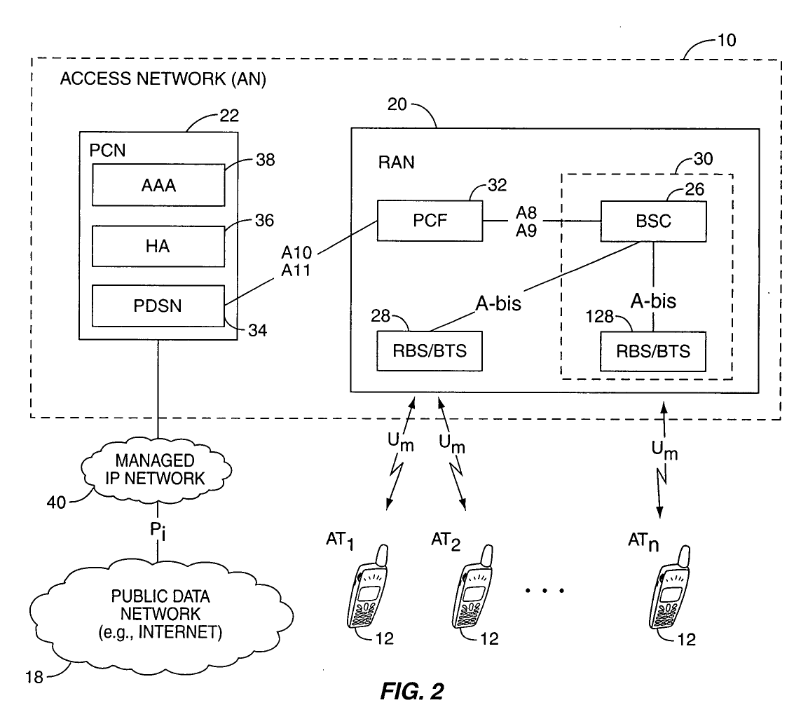

FIG. 2 illustrates the packet data side of an exemplary wireless communication network, referred to as an Access Network (AN) 10. The AN 10 may be any type of wireless communication network, such as a CDMA network, WCDMA network, GSM/GPRS network, EDGE network, or UMTS network. In one exemplary embodiment, AN 10 is based on cdma2000 1xEV-DO standards as promulgated by the Telecommunications Industry Association (TIA), although the present invention is not limited to such implementations. Here, AN 10 communicatively couples one or more access terminals 12 to a Public Data Network (PDN) 18, such as the Internet, by providing packet data communications over an air interface. In support of this functionality, the AN 10 comprises a Radio Access Network (RAN) 20 connected to a Packet Core Network (PCN) 22.

The RAN 20 typically comprises one or more Base Station Controllers (BSCs) 26, each connected to one or more Radio Base Stations (RBS) 28 via an A-bis interface. Each RBS 28 (also known in the art as a Base Transceiver Station, or BTS) includes the transceiver resources (not shown) supporting radio communication with ATs 12, such as modulators/demodulators, baseband processors, radio frequency (RF) power amplifiers, antennas, etc. The combination of a BSC 26 and a RBS/BTS 28 form a Base Station (BS) 30. Note that a given BSC 26 may be part of more than one BS 30. In operation, a BS 32 transmits packet data to ATs 12 on forward link channels, and receives packet data from the ATs 12 on reverse link channels.

The BSC 26 is communicatively coupled to the PCN 22 via a Packet Control Facility (PCF) 32. The BSC 26 connects to the PCF 32 over an A8 interface carrying user traffic and an A9 interface carrying signaling. The PCF 32 manages the buffering and relay of data packets between the BS 30 and the PCN 22. As those of skill in the art will recognize, the PCF 32 may be part of the BSC 26, or may comprise a separate network entity.

The PCN 22 comprises a Packet Data Serving Node (PDSN) 34, a Home Agent (HA) 36, and an Authentication, Authorization, and Accounting (AAA) server 38. The PCN 22 may couple to the PDN 18 through a managed IP network 40, which operates under the control of the AN 10. The IP network 40 connects to the PDN 18 via a Pᵢ interface, or alternatively another industry standard packet data communication protocol, such as Transport Control Program/Internet Protocol (TCP/IP). Alternatively, the PCN 22 may couple directly to the PDN 18, such as the Internet.

The PDSN 34 provides packet routing services, maintaining routing tables and performing route discovery. The PSDN 34 additionally manages the Radio-Packet (R-P) interface and Point-to-Point Protocol (PPP) sessions for mobile users, assigning authenticated ATs 12 an IP address from a pool of addresses. The PSDN 34 additionally frames data such as Broadcast/Multicast Services (BCMCS) media streams for transmission across the RAN to the BS 30 for transmission to one or more ATs 12. The PSDN 34 also provides Foreign Agent (FA) functionality for registration and service of network visitors, and initiates authentication procedures with the AAA server 38. The PSDN is communicatively coupled to the PCF 32 via an A10 interface for user traffic and an A11 interface for signaling. HA 36 operates in conjunction with PDSN 34 to authenticate Mobile IP registrations and to maintain current location information in support of packet tunneling and other traffic redirection activities. The AAA server 38 provides authentication, authorization and accounting services for the PSDN 34.

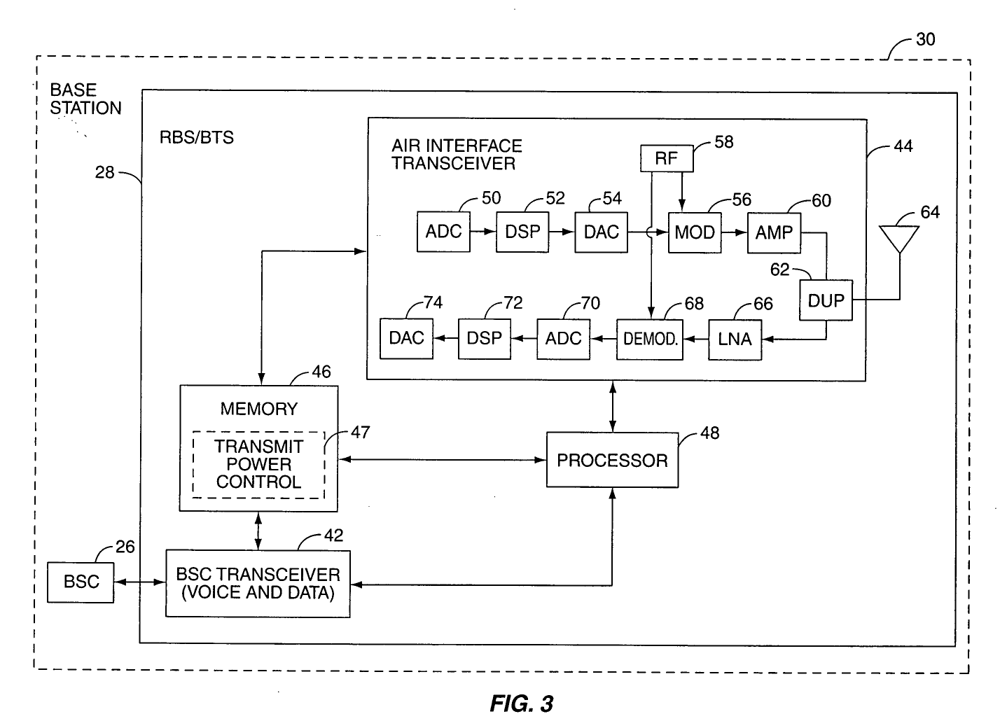

FIG. 3 depicts a functional block diagram of a BS 30, comprising a BSC 26 and a RBS/BTS 28. The RBS/BTS 28 includes a BSC transceiver 42 for communicating voice and data with the BSC 26. The BSC transceiver passes voice and data to an air interface transceiver 44, such as through buffers in memory 46. A processor 48 controls overall operation of the RBS/BTS 28.

The processor 48 is a stored program microprocessor, microcontroller, digital signal processor, or the like, as well known in the art. The processor 48 controls the overall operation of the RBS/BTS 28, executing programs from memory 46, which may comprise RAM (SRAM, DRAM, SDRAM, FLASH, etc.), ROM (PROM, EPROM, EEPROM, etc.), and magnetic or optical media. The memory 46 may store software modules for execution by the processor 48, such as a transmit power control function 47 that is operative to control the power at which packet data channel signals are transmitted from the BS 30 to ATs 12.

The air interface transceiver 44 includes transmit and receive circuits necessary to effect two-way voice and data communication across a wireless communication link. The transmitter chain may include an Analog to Digital Converter (ADC) 50 to convert voice signals from the BSC 26 to digital format. Alternatively, digital data from the BSC 26 may bypass the ADC 50 and be routed directly to a Digital Signal Processor (DSP) 52. The DSP 52 encodes the digital voice and/or data according to a Transmission Format (TF) selected by the processor 48 in response to a DRC index received from a AT 12. The TF may be the canonical TF for the associated DRC index, or it may be a non-canonical TF (for DRC indices associated with more than one TF).

The encoded voice or data is then converted to analog format by a Digital to Analog Converter (DAC) 54. A modulator 56, receiving a Radio Frequency (RF) signal from an oscillator 58 modulates the encoded signal onto an RF carrier, and passes the modulated signal to a power amplifier 60. The amplifier 60 boosts the modulated signal to an appropriate and required power level under the control of the processor 48. According to one or more embodiments of the present invention, the transmit power level to which the amplifier 60 boosts the modulated signal is controlled by a transmit power control function 47, and depends on whether the TF selected by the processor 48 is a canonical or non-canonical TF for an associated DRC index. The encoded, modulated, amplified signal is routed by a duplexer 62 to an antenna 64 for transmission to one or more ATs 12.

In the receiver chain, signals received by the antenna 64 from a AT 12 are routed by the duplexer 62 to a Low Noise Amplifier (LNA) 66; a demodulator 68, receiving an intermediate frequency signal from an oscillator 58, for recovering a baseband signal from the carrier signal; an ADC 70 to convert the baseband signal to digital format; and a DSP 72 for decoding and baseband processing of the signal. Digitally encoded speech signals are further passed to a DAC 74 for converting into analog format. The data and/or voice signals are then transferred by the BSC transceiver 42 to the BSC 26.

Those of skill in the art will recognize that the transceiver 44 as depicted in FIG. 3 is a functional representation only; in any given implementation, circuits such as the DSPs 52 and 72, the ADCs 50 and 70, and/or the DACs 54 and 74 may be shared between the transmit and receive chains. In some embodiments, the DSP 52, 72 functions may be performed directly by the processor 48. In general, the transceiver 44 includes all circuits and functionality necessary to comprise a fully functional duplex wireless transceiver in accordance with the protocol of the AN 10.

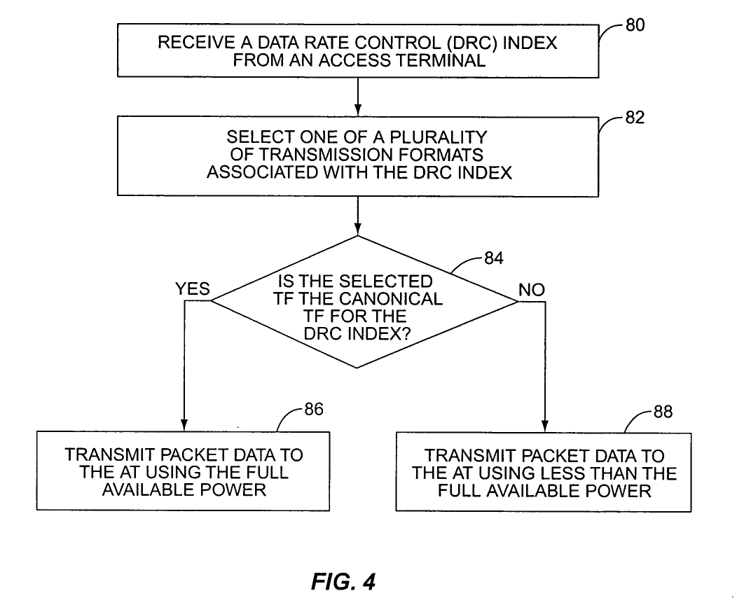

According to one or more embodiments, the transmit power control function 46 determines the transmit power (i.e., the output power of the amplifier 60) of forward link packet data channel signals according to a method depicted in flow diagram form in FIG. 4. A Base Station (BS) 30 receives a Dynamic Rage Change (DRC) index from an Access Terminal (AT) 12 (block 80). The BS 30 selects one of a potential plurality of Transmission Formats (TF) associated with the DRC index (block 82). If the selected TF is the canonical TF for the DRC index (block 84), then the BS 30 transmits packet data to the AT 12 over the forward link packet data channel at full available power (block 86). This ensures that a target Frame Error Rate (FER), such as for example 1%, can be achieved with the nominal transmit duration.

However, if the selected TF is a non-canonical TF for the DRC index (block 84)—resulting in a shorter packet size as compared with the canonical TF—the actual FER can be expected to be lower than the target FER for the canonical TF. In other words, the same FER may be achieved by transmitting packet data to the AT 12 over the forward link packet data channel at less than the full available power (block 86). The actual transmit power may be determined in a number of ways.

In one embodiment, the transmit power is configured as a function of the FER requirements, the payload size (that is, the physical layer format associated with the packet) and the packet format. For example, the packet may be formatted as single-user or multi-user—that is, addressed to one AT 12 or to two or more ATs 12. In the latter case, a higher transmit power may be chosen for a multi-user packet than for a single-user packet. In another embodiment, the transmit power may be based on the selected TF. In another embodiment, the transmit power may be based on the Quality of Service (QoS) needs of the packet. In still another embodiment, the transmit power may be based the current load of the AN 10, or of the relevant cell or sector thereof.

By dynamically selecting the transmit power of packets encoded in a non-canonical TF as a level less than the full available transmit power, the BS 30 may achieve a target FER and achieve better power efficiency (as compared to transmission at full available power). More importantly, the reduced power transmission results in less interference to other cells. That is, other cells experienced an improved Eb/Nt and hence a higher effective throughput. As CDMA is an interference-limited system, reducing interference increases overall system capacity. In addition, since the 1xEV-DO system is rate-controlled based on the forward link, the present invention has no impact on legacy channels.

In one embodiment, the transmit power may be dynamically selected for different H-ARQ sub-packet transmissions, based on the NAK/ACK received. For example, when the BS 30 determines that packet that may be transmitted at less than full power, it may significantly reduce the transmit power on a first transmission, and increased the transmit power based on a NAK returned by the AT 12 on a H-ARQ channel. The relative power levels and the frequency of adjustment of the transmit power may be based on a variety of factors, such as the load, the traffic type, and the modulation scheme utilized. For multi-user packets, the transmit power and frequency of adjustment thereof may additionally be based on the number of users carried in the multi-user packet, the number of ACKs/NAKs received so far, and if possible the relative priorities among the users in a multi-user packet.

In a broadcast cell, the transmit power may be reduced from full available power for all of the ATs 12 in the cell, depending on channel quality reports and the amount of traffic to be transmitted.

In multi-carrier cells, where the selection of carriers and the transmit power level of each carrier can be controlled by the BS 30, different carriers may be dynamically allocated power based on the number of carriers, channel quality reports from ATs 12, the system load, and traffic types. Additionally, in a multi-carrier cell, a smaller effective cell size may be created for special traffic needs by reducing the pilot power.

Although described herein with respect to CDMA2000 1xEV-DO, the present invention is not so limited, and may be applied to other systems, such as 1xEV-DV or WCDMA. In general, the BS receives an indication of channel quality from one or more ATs, which may for example comprise a Data Rate Control (DRC) index, a Channel Quality Indicator (CQI), a combination of DRC and CQI, or some other indication of the channel quality. From the received channel quality indication, the BS 30 calculates a maximum channel-supported data rate. As used herein, the maximum channel-supported data rate is the maximum data rate that channel conditions will support to a particular AT 12 at a given time. However, the BS 30 may not be able to transmit data at the maximum channel-supported data rate. The BS 30 must consider a variety of factors, such as the amount of pending traffic, in addition to the maximum channel-supported data rate in determining the required data rate. As used herein, the required data rate is the rate at which data is actually transmitted by the BS 30 to one or more ATs 12.

According to the present invention, the BS 30 may compare the maximum channel-supported data rate to the required data rate, and whenever the required data rate is less than the maximum channel-supported data rate, the BS 30 may transmit data at less than full available power, and still achieve target FER while reducing interference in the system.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of transmitting packet data from an Access Network (AN) to one or more Access Terminals (AT) in a wireless communication system, comprising:
receiving at the AN a Data Rate Control (DRC) index from a AT;
selecting one of a plurality of Transmission Formats (TF) associated with the DRC index; and
if the selected TF is a non-canonical TF for the DRC index, transmitting packet data to the AT at less than full available power.

2. The method of claim 1 wherein the transmit power is selected as a function of the required Frame Error Rate (FER).

3. The method of claim 1 wherein the transmit power is selected as a function of the payload size of the data packet to be transmitted.

4. The method of claim 1 wherein the transmit power is selected as a function of the format of the data packet to be transmitted.

5. The method of claim 4 wherein a multi-user packet is transmitted at a higher power level than a single-user packet.

6. The method of claim 1 wherein the transmit power is selected as a function of the required FER, the packet payload size, and whether the packet is formatted as a single- or multi-user packet.

7. The method of claim 1 wherein the transmit power is selected as a function of the selected TF.

8. The method of claim 1 wherein the transmit power is selected as a function of the Quality of Service (QoS) requirements of the data packet to be transmitted.

9. The method of claim 1 wherein the transmit power is selected as a function of the current AN system load.

10. A method of reducing interference in a code division multiple access wireless Access Network (AN), comprising:
receiving at the AN a Data Rate Control (DRC) index from an Access Terminal (AT);
selecting one of a plurality of Transmission Formats (TF) associated with the DRC index; and
if the selected TF is a non-canonical TF for the DRC index, transmitting one or more data packets to the AT at less than full available power, thereby reducing the interference presented to other ATs as compared to a full power transmission of the data packets.

11. A base station in an Access Network (AN) operative to transmit packet data to an Access Terminal (AT), comprising:
an air interface transceiver having a variable power amplifier;
a processor controlling the variable power amplifier and operative to select one of a plurality of Transmission Formats (TF) associated with a DRC index received from the AT; and
a transmit power control function operative to transmit packet data to the AT at a transmit power less than the full available power if the selected TF is a non-canonical TF for the DRC index.

12. The base station of claim 11 wherein transmit power control function selects the transmit power as a function of the required Frame Error Rate (FER).

13. The base station of claim 11 wherein the transmit power control function selects the transmit power as a function of the payload size of the data packet to be transmitted.

14. The base station of claim 11 wherein the transmit power control function as a function of the format of the data packet to be transmitted.

15. The base station of claim 14 wherein a multi-user packet is transmitted at a higher power level than a single-user packet.

16. The base station of claim 11 wherein the transmit power control function selects the transmit power as a function of the required FER, the packet payload size, and whether the packet is formatted as a single- or multi-user packet.

17. The base station of claim 11 wherein the transmit power control function selects the transmit power as a function of the selected TF.

18. The base station of claim 11 wherein transmit power control function selects the transmit power as a function of the Quality of Service (QoS) requirements of the data packet to be transmitted.

19. The base station of claim 11 wherein the transmit power control function selects the transmit power as a function of the current AN system load.

20. A method of transmitting packet data from an Access Network (AN) to one or more Access Terminals (AT) via a Base Station (BS) in a wireless communication system, comprising:
receiving at the BS an indication of channel quality from a AT;
calculating a maximum channel-supported data rate from the channel quality indication;
calculating a required data rate at the BS;
comparing the maximum channel-supported data rate to the required data rate; and
if the required data rate is less than the maximum channel-supported data rate, transmitting packet data to the AT at less than full available power.

21. The method of claim 20 wherein the indication of channel quality comprises a Data Rate Control (DRC) index.

22. The method of claim 20 wherein the indication of channel quality comprises a Channel Quality Indicator (CQI) signal.

23. The method of claim 20 wherein the transmit power is selected as a function of the required Frame Error Rate (FER).

24. The method of claim 20 wherein the transmit power is selected as a function of the payload size of the data packet to be transmitted.

25. The method of claim 20 wherein the transmit power is selected as a function of the format of the data packet to be transmitted.

26. The method of claim 25 wherein a multi-user packet is transmitted at a higher power level than a single-user packet.

27. The method of claim 20 wherein the transmit power is selected as a function of the required FER, the packet payload size, and whether the packet is formatted as a single- or multi-user packet.

28. The method of claim 20 wherein the transmit power is selected as a function of the Quality of Service (QoS) requirements of the data packet to be transmitted.

29. The method of claim 20 wherein the transmit power is selected as a function of the current BS system load.

30. The method of claim 20 wherein the BS serves a broadcast cell, and wherein transmitting packet data to the AT at less than full available power comprises transmitting packet data to all ATs in the cell at less than full available power.

31. The method of claim 30 wherein the transmit power is selected in response to channel quality reports from one or more ATs.

32. The method of claim 30 wherein the transmit power is selected in response to the amount of traffic to be broadcast.

33. The method of claim 20 wherein the BS controls a plurality of carriers, and wherein transmitting packet data to the AT at less than full available power comprises transmitting packet data to the AT not one or more carriers at less than full available power.

34. The method of claim 33 where in the transmit power of each carrier is determined based on the BS system load.

35. The method of claim 33 wherein the transmit power of each carrier is determined based on the traffic type.

36. The method of claim 33 wherein the transmit power of each carrier is determined based on the number of carriers.

37. The method of claim 33 wherein the BS effectively creates a smaller size cell by reducing the transmit power of one or more carriers below the full available power.

38. A method of transmitting packet data from an Access Network (AN) to one or more Access Terminals (AT) via a Base Station (BS) in a wireless communication system, comprising:
receiving at the BS an indication of channel quality from a AT;
calculating a maximum channel-supported data rate from the channel quality indication;
calculating a required data rate at the BS;
comparing the maximum channel-supported data rate to the required data rate; and
if the required data rate is less than the maximum channel-supported data rate, transmitting the packet data in sub-packets at varying power levels, the transmit power of at least one sub-packet being less than full available power.

39. The method of claim 38 wherein the transmit power of each sub-packet is determined in response to the number of ACKs/NAKs received by the BS from the AT on a H-ARQ channel.

40. The method of claim 39 wherein the first sub-packet of a data packet is transmitted at full available power, and wherein at least one subsequent sub-packet of the data packet is transmitted at less than full available power.

41. The method of claim 39 wherein the transmit power of a first sub-packet transmitted is a first power level less than full available power, and wherein a second sub-packet is transmitted at a second power level greater than the first power level.

42. The method of claim 41 where in the transmit power level and frequency of adjustment of the transmit power level are determined in response to the BS system load.

43. The method of claim 41 where in the transmit power level and frequency of adjustment of the transmit power level are determined in response to the traffic type.

44. The method of claim 41 where in the transmit power level and frequency of adjustment of the transmit power level are determined in response to the modulation scheme used.
